(19) United States
(12) Patent Application Publication
(10) Pub. No.: US 2025/0199378 A1
(43) Pub. Date: Jun. 19, 2025

(54) TERAHERTZ DUAL-COMB SPECTRUM STABILIZATION SYSTEM

(71) Applicant: SHANGHAI INSTITUTE OF MICROSYSTEM AND INFORMATION TECHNOLOGY CHINESE ACADEMY OF SCIENCES, Shanghai (CN)

(72) Inventors: Hua Li, Shanghai (CN); Xu Hong Ma, Shanghai (CN); Zi Ping Li, Shanghai (CN); Jun Cheng Cao, Shanghai (CN)

(73) Assignee: SHANGHAI INSTITUTE OF MICROSYSTEM AND INFORMATION TECHNOLOGY CHINESE ACADEMY OF SCIENCES, Shanghai (CN)

(21) Appl. No.: 18/848,920

(22) PCT Filed: Jun. 14, 2022
(86) PCT No.: PCT/CN2022/098502

§ 371 Date: Sep. 20, 2024

(30) Foreign Application Priority Data
Mar. 28, 2022 (CN) 202210309420.2

(51) Int. Cl. G02F 1/35

(52) U.S. Cl. CPC G02F 1/3546; G02F 2203/13; G02F 2203/56

(57) ABSTRACT

The invention relates to a terahertz dual-comb spectrum stabilization system, including an optical loop for coupling a first optical frequency comb signal (OFCS) to a second OFCS; and a frequency mixer for performing frequency mixing on the coupled first OFCS and second OFCS to generate a dual-comb signal. A local oscillator signal end of the frequency mixer is connected to a multi-chain frequency multiplication chain, the multi-chain frequency multiplication chain is used for performing frequency multiplication processing on a radio frequency signal, a local oscillator frequency in terahertz frequency range is generated the local oscillator frequency in terahertz frequency range is respectively mixed with the first OFCS and the second OFCS in the frequency mixer, and two down-converted OFCSs are generated in microwave frequency range. One line of comb teeth of the two down-converted OFCSs are respectively locked to obtain a stable multi-heterodyne dual-comb spectrum.

### TECHNICAL FIELD

The present invention relates to the technical field of semiconductor optoelectronic device applications, in particular to a terahertz dual-comb spectrum stabilization system.

### BACKGROUND

Optical frequency combs consist of a series of equally spaced and highly stable frequency lines, featuring ultra-high frequency stability and ultra-low phase noise. They have important applications in precision spectral measurement, imaging, communication, and other fields. Optical frequency combs are defined by two fundamental frequencies: the repetition frequency and the carrier-envelope offset frequency. They are typically generated by short-pulse lasers or nonlinear optical effects. The terahertz frequency range encompasses absorption spectra of a large number of gases and chemicals. A dual-comb spectrum system based on terahertz quantum cascade laser optical frequency combs can avoid the difficulties associated with the mechanical scanning structures required by traditional spectrometers, enabling real-time and high-precision material detection. This technology can be applied in weapon, drug, and explosive security checks, non-invasive detection of biological macromolecules in medicine, communication, imaging, and related applications. The key prerequisite for these applications is a stable terahertz dual-comb system.

Terahertz dual-comb spectrum refers to the multi-heterodyne spectrum formed by two terahertz quantum cascade laser optical frequency combs with slightly different repetition frequency. In theory, a fully locked dual-comb system can be achieved by separately locking the carrier-envelope offset frequency and the repetition frequency of each individual optical frequency comb. Active/passive mode-locking mechanisms are commonly used to lock the repetition frequency of the terahertz quantum cascade laser optical frequency combs and have been extensively studied. Regarding the carrier-envelope offset frequency (often abbreviated as the carrier offset frequency), due to the limitations imposed by the spectral range of terahertz optical frequency combs, it is difficult to octave the frequency span, making direct locking of the carrier offset frequency impractical. Instead, a commonly used method involves generating a highly stable pulsed seed using a femtosecond laser, which is then injected into the resonator of the quantum cascade laser optical frequency comb to replace spontaneous emission. This serves as an indirect means of locking the carrier offset frequency. However, the introduction of a femtosecond laser undoubtedly increases the size and complexity of the terahertz dual-comb equipment, limiting its integration and miniaturization.

### SUMMARY

The technical problem underlying the present invention is to provide a terahertz dual-comb spectrum stabilization system capable of locking the carrier offset frequency without introducing a femtosecond laser.

The technical solution adopted by the present invention to solve the technical problem thereof is to provide a terahertz dual-comb spectrum stabilization system, including:
an optical loop, used for coupling a first optical frequency comb signal to a second optical frequency comb signal;
a frequency mixer, used for performing frequency mixing on the coupled first optical frequency comb signal and second optical frequency comb signal to generate a dual-comb signal; wherein a local oscillator signal end of the frequency mixer is connected to a multi-chain frequency multiplication chain, the multi-chain frequency multiplication chain is used for performing frequency multiplication processing on a radio frequency signal, then a local oscillator frequency in terahertz frequency range is generated by means of frequency multiplication by the frequency mixer, the local oscillator frequency in terahertz frequency range is respectively mixed with the first optical frequency comb signal and the second optical frequency comb signal in the frequency mixer, and two down-converted optical frequency comb signals are generated in microwave frequency range;
a first signal extraction device, used for extracting one comb tooth from one of the two down-converted optical frequency comb signals;
a first phase-locking device, used for locking the phase of the comb tooth extracted by the first signal extraction device;
a second signal extraction device, used for extracting one comb tooth from one of the two down-converted optical frequency comb signals; and
a second phase-locking device, used for locking the phase of the comb tooth extracted by the second signal extraction device.

The optical loop includes a first parabolic mirror, a second parabolic mirror, a beam splitter, and a third parabolic mirror, the first and second parabolic mirrors collimate the first and second optical frequency comb signals, respectively, and converge to the beam splitter mirror, and the third parabolic mirror focuses the first and second optical frequency comb signals passing through the beam splitter mirror to an optical port of the frequency mixer.

An input end of the multi-chain frequency multiplication chain is connected to a radio frequency generator, the multi-chain frequency multiplication chain multiplies a radio frequency signal generated by the radio frequency generator, and then the radio frequency signal is further multiplied to the terahertz band through the frequency mixer.

The frequency mixer is a Schottky diode harmonic mixer with the frequency multiplication function, an IF signal end of the Schottky diode harmonic mixer is connected to a spectrum analyzer through a bias-Tee.

A first low noise amplifier is disposed between the first signal extraction device and the first phase-locking device; a second low noise amplifier is disposed between the second signal extraction device and the second phase-locking device.

The first phase-locking device and the second phase-locking device both employ phase-locked loop circuits, RF terminals of both phase-locked loop circuits being connected to output terminals of the respective signal extraction devices, LO terminals being connected to the respective radio frequency generators, and output terminals being connected to corresponding current sources of the respective optical frequency comb signals.

### Beneficial Effects

By adopting the aforementioned technical solution, the present invention exhibits the following advantages and positive effects compared to existing technologies: the invention utilizes a multi-chain frequency multiplication chain and a Schottky diode harmonic mixer with the frequency multiplication function to down-convert two terahertz optical frequency combs to the microwave band. Matching microwave bandpass filters are employed to separately extract one comb tooth from each of the two microwave optical frequency combs, which are then locked to the LO signals provided by the radio frequency generators through electrical phase-locked loops. This realizes the locking of the carrier offset frequencies of the two terahertz optical frequency combs, thereby enhancing the stability of the dual-comb frequency obtained by multiheterodyne frequency measurement of the two terahertz optical frequency combs and enabling a stable terahertz dual-comb spectrum system.

### BRIEF DESCRIPTION OF THE DRAWINGS

FIG. 1 is a structural schematic diagram of an embodiment of the present invention; and

FIG. 2 is a schematic diagram of the present invention.

### DETAILED DESCRIPTION

The invention will now be further illustrated with reference to specific examples. It should be understood that these examples are only for illustrating the present invention and are not intended to limit the scope of the present invention. In addition, it should be understood that after reading the teachings of the present invention, those skilled in the art can make various changes or modifications to the present invention, and these equivalents also fall within the scope defined by the appended claims.

Embodiments of the present invention relate to a terahertz dual-comb spectrum stabilization system, including: an optical loop, used for coupling a first optical frequency comb signal to a second optical frequency comb signal; a frequency mixer, used for performing frequency mixing on the coupled first optical frequency comb signal and second optical frequency comb signal to generate a dual-comb signal; wherein a local oscillator signal end of the frequency mixer is connected to a multi-chain frequency multiplication chain, the multi-chain frequency multiplication chain is used for performing frequency multiplication processing on a radio frequency signal, then a local oscillator frequency in terahertz frequency range is generated by means of frequency multiplication by the frequency mixer, the local oscillator frequency in terahertz frequency range is respectively mixed with the first optical frequency comb signal and the second optical frequency comb signal in the frequency mixer, and two down-converted optical frequency comb signals are generated in microwave frequency range; a first signal extraction device, used for extracting one comb tooth from one of the two down-converted optical frequency comb signals; a first phase-locking device, used for locking the phase of the comb tooth extracted by the first signal extraction device; a second signal extraction device, used for extracting one comb tooth from one of the two down-converted optical frequency comb signals; and a second phase-locking device, used for locking the phase of the comb tooth extracted by the second signal extraction device.

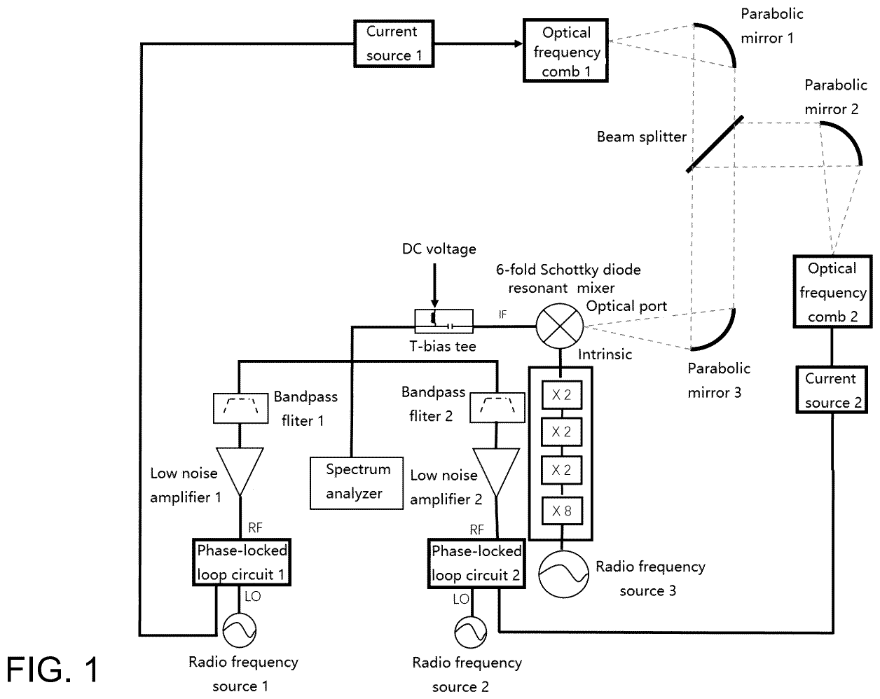

In this embodiment, the frequency mixer uses a Schottky diode harmonic mixer, the first signal extraction device and the second signal extraction device are both bandpass filters, and the first phase-locking device and the second phase-locking device both utilize phase-locked loop circuits. As shown in FIG. 1, the optical frequency comb 1 and the optical frequency comb 2 are coupled via an optical loop and mixed at the Schottky diode harmonic mixer to generate a dual-comb signal, while the two optical frequency comb signals are separately mixed with a local oscillator frequency that has been frequency-doubled through the multi-chain chain and up-converted to the terahertz band by the Schottky diode harmonic mixer to generate two microwave optical frequency comb signals; one comb tooth of one of the two microwave optical frequency combs is extracted by two bandpass filters, respectively, and the comb teeth are phase-locked, i.e., carrier offset frequency locking of the terahertz optical frequency comb is achieved.

According to the frequency definition of the optical frequency comb, as in Equation (1), the frequency fₙ of the n-th comb tooth in the optical frequency comb is equal to the sum of the carrier-envelope offset frequency f_{ceo} and the n-fold (n is a positive integer) repetition frequency fᵣₑₚ (frep).

$${f}_{n} = {f}_{ceo} + {nf}_{rep} \qquad ( 1 )$$

Based on the method described above, the frequency fₘ of the m-th comb tooth is mixed with the up-converted local oscillator frequency to generate a down-converted signal, which is then locked with a phase-locked loop (PLL), and the optical frequency comb is re-represented using this locked fₘ:

$$\begin{matrix}{f}_{m} = {f}_{ceo} + {mf}_{rep} \\ {f}_{n} = {f}_{m} + ( n - m ) {f}_{rep}\end{matrix} \qquad ( 2 )$$

As can be seen from Equation (2), the frequency fₘ of the m-th comb tooth can serve as the carrier-envelope offset frequency of the optical frequency comb and locking of fₘ effectively locks the optical frequency comb. This embodiment achieves locking of the carrier offset frequency of the terahertz optical frequency comb by locking one of its comb teeth, which directly acts on the optical frequency comb and can affect all the optical frequency comb modes involved in the generation of dual combs, thereby enhancing the stability of all comb teeth in the dual combs.

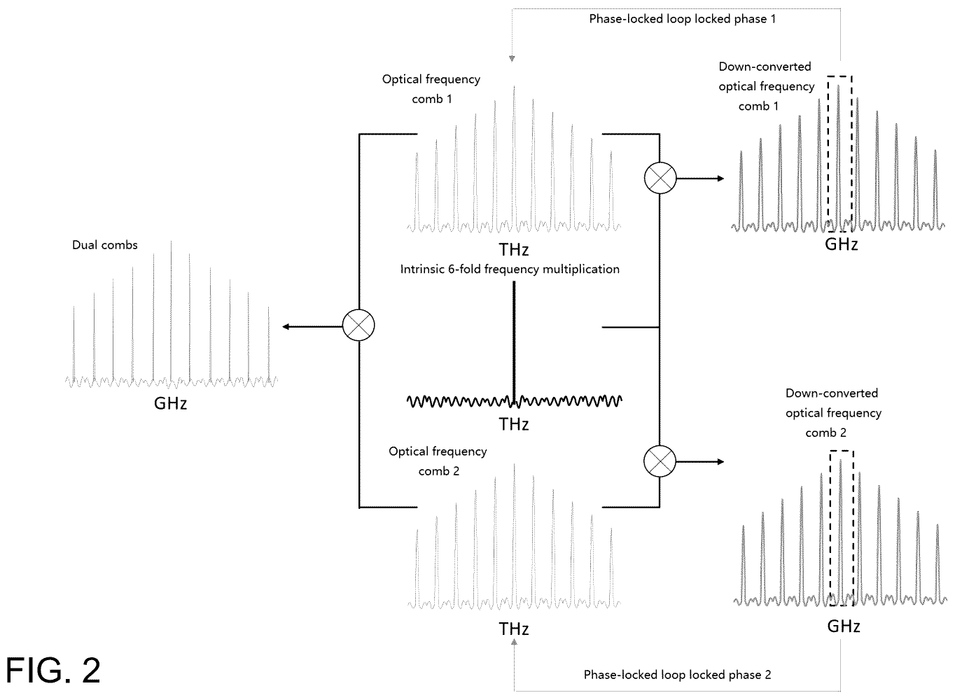

FIG. 2 illustrates the principle of forming a stable dual-comb spectrum system: the radio frequency signal up-converted to the terahertz (THz) is mixed with the optical frequency comb 1 and the optical frequency comb 2, respectively, through the frequency mixer, to generate the down-converted microwave optical frequency comb 1 and the microwave optical frequency comb 2 in the GHz frequency range, one comb tooth is extracted from each by filtering, and phase-locking is achieved using the respective phase-locked loop circuits, thereby locking the carrier offset frequency of the original optical frequency comb. The two locked THz optical frequency combs undergo multiheterodyne measurement to obtain a stable dual-comb spectrum system.

The optical loop in this embodiment includes a parabolic mirror 1, a parabolic mirror 2, a parabolic mirror 3 and a beam splitter; the optical frequency combs 1 and 2 are collimated via the parabolic mirror 1 and the parabolic mirror 2, respectively, and then converged on the beam splitter, and finally are focused as optical signals via the parabolic mirror 3 to the optical port of the Schottky diode harmonic mixer.

The local oscillator frequency is generated through frequency multiplication by a multi-chain frequency multiplication chain. An original radio frequency signal produced by the radio frequency generator 3 undergoes a frequency multiplication process of ×8×2×2×2 by the multi-chain frequency multiplication chain, resulting in a radio frequency signal with a frequency that is 64 times the original frequency. This signal is input into the Schottky diode harmonic mixer as the local oscillator frequency. The signal coverage of the radio frequency generator 3 should encompass the comb tooth spacing of the optical frequency comb, with an intensity that meets the requirements of the local oscillator multi-chain chain frequency multiplication, Schottky diode harmonic mixer frequency multiplication, and phase-locked loop circuits.

The Schottky diode harmonic mixer possesses the frequency multiplication capability, enabling 6-fold frequency multiplication of the local oscillator frequency through the application of a DC voltage input by a bias-Tee. When the THz optical signal is mixed with the 6-fold frequency-multiplied local oscillator frequency in the Schottky diode harmonic mixer, an IF signal is output. The IF signal contains down-converted microwave optical frequency comb signals resulting from beat frequency measurement of the optical frequency comb 1 and the optical frequency comb 2 with the local oscillator frequency, as well as the dual-comb signal generated by multiheterodyne measurement between the optical frequency comb 1 and the optical frequency comb 2. These signals can be detected using a spectrum analyzer. The response band of the Schottky diode harmonic mixer is matched to the lasing band of the optical frequency comb, and for the terahertz optical frequency comb, a mixer with a corresponding matched band should be selected. The mixer has a certain intermediate frequency bandwidth that is capable of covering both the dual-comb and microwave optical frequency comb bands. For instance, if the dual-comb carrier frequency is 3 GHZ, the intermediate frequency bandwidth of the frequency mixer must be greater than 3 GHz.

The IF signal is input into the bandpass filter after passing through the bias-Tee. The bandpass filter extracts a single comb tooth of the microwave optical frequency comb signal from the IF signal. The bandpass filter possesses the capability to filter out one single microwave optical frequency comb tooth. For instance, if the repetition frequency of the optical frequency comb is 6 GHz, the resulting comb tooth spacing of the down-converted microwave optical frequency comb will also be 6 GHz. Consequently, the bandwidth of the bandpass filter is required to be greater than 6 GHz but less than 12 GHz.

The bandpass filter 1 and the bandpass filter 2 respectively extract one comb tooth of the microwave optical frequency comb down-converted from the optical frequency comb 1 and one comb tooth of the microwave optical frequency comb down-converted from the optical frequency comb 2 in the IF signal, and they are amplified by the low noise amplifiers and input to the phase-locked loop circuit 1 and the phase-locked loop circuit 2 as RF signals, respectively. An output signal of a voltage-controlled oscillator in the phase-locked loop circuit contributes to the bias current and the operating temperature of a target optical frequency comb, and the length of a laser resonant cavity. The RF ports of the two phase-locked loop circuits are connected to the output ends of their respective bandpass filters, while the LO ports are connected to the respective referenced radio frequency generators. The output ports of the phase-locked loop circuits are connected to the current sources of their respective optical frequency combs, enabling phase locking of the filtered comb teeth according to the LO signals provided by the radio frequency generators. The low noise amplifier employed is a microwave low noise amplifier, designed to amplify the extracted single comb tooth of the microwave optical frequency comb. It is required that the phase-locked loop circuits are matched to the carrier offset frequencies of the microwave optical frequency combs. For instance, if the microwave optical frequency comb carrier is 3 GHZ, the range of the RF signal input into the phase locked loop circuit is required to cover 3 GHz.

As a result, this invention utilizes the multi-chain frequency multiplication chain and the Schottky diode harmonic mixer with the frequency multiplication capability to down-convert two optical frequency combs into the microwave frequency range, forming two microwave optical frequency combs. By employing matched microwave bandpass filters, one single comb tooth from each microwave optical frequency comb is extracted and subsequently locked to a local oscillator signal provided by a radio frequency generator through the electrical phase-locked loop. This process achieves carrier offset frequency locking of the terahertz optical frequency combs, thereby enhancing the stability of the dual-comb frequency obtained by multiheterodyne measurement of the two terahertz optical frequency combs. Ultimately, a stable dual-comb spectrum system is realized.

Below, a specific example is provided to further illustrate the present invention. It is worth noting that those skilled in the art may make various modifications or alterations to this example, including but not limited to changing the type of laser (such as a gas laser, a semiconductor laser, etc.), changing the type of frequency mixer, and adjusting the operating wavelength. Such modifications shall be considered equivalent forms of this embodiment and fall within the scope defined by the appended claims of this application.

Step S1: in this example, the optical frequency combs to be phase-locked are both terahertz quantum cascade laser optical frequency combs. The lasing frequency of the laser shifts linearly with the driving current. Specifically, the optical frequency comb 1 has a center frequency of 4.2 THz and a repetition frequency of 6 GHZ, while the optical frequency comb 2 is a terahertz optical frequency comb with the same center frequency of 4.2 THz but a repetition frequency of 6.01 GHz. The corresponding minimum comb tooth spacing between the optical frequency comb 1 and the optical frequency comb 2 is around 3 GHz, meaning that the dual-comb carrier generated by mixing of the optical frequency comb 1 and the optical frequency comb 2 is around 3 GHz.

Step S2: three parabolic mirrors and a beam splitter are provided to construct an optical loop. The optical frequency combs 1 and 2 are collimated via the parabolic mirror 1 and the parabolic mirror 2, respectively, and then converged on the beam splitter, and finally are focused as optical signals via the parabolic mirror 3 on the optical port of the Schottky diode harmonic mixer.

Step S3: a Schottky diode harmonic mixer is provided as the frequency mixer, which has a frequency bandwidth of 4 GHz and operates at room temperature. It can achieve 6-fold frequency multiplication for the local oscillator frequency and mix the optical signal with the local oscillator frequency to output an IF signal with a bandwidth of 200 MHz. A DC voltage connected to a bias-Tee is also provided for powering the Schottky diode harmonic mixer.

Step S4: a multi-chain chain is provided for frequency multiplication of an initial signal. The initial signal, generated by the radio frequency generator 3, has a frequency of 11 GHz. It undergoes a multi-chain chain frequency multiplication process of ×8×2×2×2, namely, 64 times, yielding a radio frequency signal with a frequency of 704 GHz. This signal is then used as the local oscillator frequency input to the Schottky diode resonant mixer.

Step S5: the band pass filters and the microwave low noise amplifiers are provided. The passband frequencies of the bandpass filters are 2.99 GHz ˜ 3.01 GHz and 3.09 GHZ˜ 3.11 GHZ, respectively, and the gain of the microwave low noise amplifier is 40 dB. The Schottky diode harmonic mixer and the bias-Tee are connected to two bandpass filters via high-frequency coaxial cables, and the bandpass filters are connected to the microwave low noise amplifier through the high-frequency coaxial cables.

Step S6: two current sources are provided to power the optical frequency comb 1 and the optical frequency comb 2, respectively.

Step S7: the phase-locked loop circuits and three radio frequency generators are provided. For two phase-locked loop circuits, the microwave low-noise amplifiers are connected to the RF ports of the phase-locked loop circuits via high-frequency coaxial cables. The radio frequency generator 1 and the radio frequency generator 2 are connected to the LO ports of their respective phase-locked loop circuits via the high-frequency coaxial cables. The current sources connected to the optical frequency combs are then connected to the output ports of the phase-locked loop circuits via the coaxial cables, allowing the driving currents of the optical frequency comb 1 and optical frequency comb 2 to be regulated by their respective phase-locked loop circuits. The radio frequency generator 3, with a frequency of 11 GHz, serves as the initial signal and is input to the multi-chain chain for generating the local oscillator frequency.

Step S7: through monitoring with a spectrum analyzer, after two bandpass filters filter out individual radio frequency comb teeth (3 GHZ and 3.1 GHz teeth), the radio frequency generator 1 and the radio frequency generator 2 provide local oscillator signals with frequencies of 3 GHz and 3.1 GHZ, respectively, to the phase-locked loop circuits, both at a power level of 0 dBm. The phase-locked loop circuits are utilized to achieve individual carrier offset frequency locking for the terahertz optical frequency combs.

Step S8: after both optical frequency combs are fully locked, the dual-comb signal formed by multiheterodyne measurement of the two optical frequency combs within the IF signal output from the frequency mixer is monitored using a spectrum analyzer. This represents the stable dual-comb spectrum.

The present embodiment utilizes the multi-chain frequency multiplication chain and the Schottky diode harmonic mixer with the frequency multiplication capability to down-convert two terahertz optical frequency combs to the microwave frequency range, forming microwave optical frequency combs. By leveraging the mature detection, filtering, amplification, and other technologies available in the microwave frequency range, an electrical phase-locked loop is employed to lock the down-converted microwave optical frequency comb tooth, thereby achieving carrier offset frequency locking for the terahertz optical frequency comb. This, in turn, realizes a stable dual-comb system, significantly enhancing the stability of the terahertz dual-comb spectrum system. This invention achieves the locking of the carrier offset frequency of the terahertz optical frequency combs, has great application prospect in high-speed and high-resolution precise spectral measurement of substances in the terahertz band, and is expected to be used in the fields of substance analysis and the like.

1. A terahertz dual-comb spectrum stabilization system, comprising:
an optical loop, used for coupling a first optical frequency comb signal to a second optical frequency comb signal;
a frequency mixer, used for performing frequency mixing on the coupled first optical frequency comb signal and second optical frequency comb signal to generate a dual-comb signal; wherein a local oscillator signal end of the frequency mixer is connected to a multi-chain frequency multiplication chain, the multi-chain frequency multiplication chain is used for performing frequency multiplication processing on a radio frequency signal, then a local oscillator frequency in terahertz frequency range is generated by means of frequency multiplication using the frequency mixer, the local oscillator frequency in terahertz frequency range is respectively mixed with the first optical frequency comb signal and the second optical frequency comb signal in the frequency mixer, and two down-converted optical frequency comb signals are generated in microwave frequency range;
a first signal extraction device, used for extracting one comb tooth from one of the two down-converted optical frequency comb signals;
a first phase-locking device, used for locking the phase of the comb tooth extracted by the first signal extraction device;
a second signal extraction device, used for extracting one comb tooth from one of the two down-converted optical frequency comb signals;
a second phase-locking device, used for locking the phase of the comb tooth extracted by the second signal extraction device.

2. The terahertz dual-comb spectrum stabilization system according to claim 1, wherein the optical loop comprises a first parabolic mirror, a second parabolic mirror, a beam splitter, and a third parabolic mirror, the first parabolic mirror and second parabolic mirror collimate the first optical frequency comb signal and the second optical frequency comb signal, respectively, and converge to the beam splitter mirror, and the third parabolic mirror focuses the first optical frequency comb signal and the second optical frequency comb signal passing through the beam splitter mirror to an optical port of the frequency mixer.

3. The terahertz dual-comb spectrum stabilization system according to claim 1, wherein an input end of the multi-chain frequency multiplication chain is connected to a radio frequency generator, the multi-chain frequency multiplication chain multiplies a radio frequency signal generated by the radio frequency generator, and then the radio frequency signal is further multiplied to the terahertz frequency through the frequency mixer.

4. The terahertz dual-comb spectrum stabilization system according to claim 1, wherein the frequency mixer is a Schottky diode harmonic mixer with the frequency multiplication function, an IF signal end of the Schottky diode harmonic mixer is connected to a spectrum analyzer through a bias-Tee.

5. The terahertz dual-comb spectrum stabilization system according to claim 1, wherein a first low noise amplifier is disposed between the first signal extraction device and the first phase-locking device; a second low noise amplifier is disposed between the second signal extraction device and the second phase-locking device.

6. The terahertz dual-comb spectrum stabilization system according to claim 1, wherein the first phase-locking device and the second phase-locking device both employ phase-locked loop circuits, RF terminals of both phase-locked loop circuits being connected to output terminals of the respective signal extraction devices, LO terminals being connected to the respective radio frequency generators, and output terminals being connected to corresponding current sources of the respective optical frequency comb signals.
